(19) United States
(12) Patent Application Publication
(10) Pub. No.: US 2010/0312666 A1
(43) Pub. Date: Dec. 9, 2010

(54) Method and System for Supporting Variety of Merchandise Deal Relay on On-Line Open Market Through Auxiliary Order Form

(75) Inventor: Young Bae Ku, Seoul (KR)

Correspondence Address: THE WEBB LAW FIRM, P.C., 700 KOPPERS BUILDING, 436 SEVENTH AVENUE, PITTSBURGH, PA, 15219, US

(73) Assignee: GMARKET INC., Seoul (KR)

(21) Appl. No.: 12/740,234

(22) PCT Filed: Oct. 27, 2008
(86) PCT No.: PCT/KR2008/006331

§ 371 Date: Aug. 25, 2010

(30) Foreign Application Priority Data
Nov. 2, 2007 (KR) 10-2007-0111440

(51) Int. Cl. G06Q 30/00

(52) U.S. Cl. 705/26.35; 705/27.1; 705/26.1; 705/26.41

(57) ABSTRACT

Provided are a method and system that can support goods transaction diversity and extend and promote electronic commercial transactions by improving a process in which a buyer provides a seller with necessary supplementary order information for ordering goods or services that are difficult to trade in an on-line mode, receiving all supplementary order information from the buyer through a supplementary order form registered in an on-line open market without exchanging additional information between the buyer and the seller in an off-line mode in relation to the sale of goods or services requiring the supplementary order information, and allowing the seller to efficiently prepare and deliver the ordered goods or services.

### TECHNICAL FIELD

The present invention relates to a method and system that facilitate the sale of goods through media such as the Internet, etc., and more particularly, to a method and system that can support goods transaction diversity and extend and promote electronic commercial transactions by improving a process in which a buyer provides a seller with necessary supplementary order information for ordering goods or services that are difficult to trade in an on-line mode, receiving all supplementary order information from the buyer through a supplementary order form registered in an on-line open market without exchanging additional information between the buyer and the seller in an off-line mode in relation to the sale of goods or services requiring the supplementary order information, and allowing the seller to efficiently prepare and deliver the ordered goods or services.

### BACKGROUND ART

Recently, many shopping malls that manage electronic commercial transactions of goods or services in on-line market places such as the Internet have appeared. Through such on-line shopping malls, buyers can conveniently buy various goods or services registered by sellers without leaving the house.

In general, in on-line open markets that facilitate a process in which buyers can buy various goods or services registered for sale by sellers, a buyer can receive goods or services by inputting basic order information about quantity, color, size, etc. of the goods or services and paying money. For example, a buyer of clothing such as T-shirts, sport shirts, dress shirts, etc. may select a quantity, color, size, etc. of desired goods described in the open market in given fields of a buyer screen or make a purchase request by recording required information upon order submission.

If needed, the buyer may desire an image, for example, a company logo, a number, or a team mark/name to be imprinted on clothing. However, there is a problem in that the general on-line open market does not receive supplementary order information such as an image to be imprinted on the clothing through a corresponding market server. In this case, the buyer pays money without considering the supplementary order information and then the seller receives and processes the supplementary order information through a special off-line method for contact with the buyer. For example, supplementary order information about goods or services are needed for a mobile phone sale requiring a subscription application form and a copy of a resident registration certificate, a sale of overseas travel goods requiring a contract document and a passport/visa, and a manufactured model sale requiring a design drawing and a description.

Accordingly, there is need for an on-line shopping mall that facilitates the smooth and efficient transaction of various goods or services using basic order information and supplementary order information received through an on-line open market without exchanging information between a buyer and a seller in an off-line mode in relation to the sale of goods or services requiring supplementary order information.

### DISCLOSURE OF INVENTION

### Technical Problem

The present invention has been made in view of the above problems, and an object of the invention is to provide an electronic commercial transaction system and method that allow a seller to efficiently prepare and deliver goods or services by receiving all supplementary order information from a buyer using various supplementary order forms registered in an on-line open market.

Another object of the present invention is to provide an electronic commercial transaction system and method that can extend and promote transactions by supporting diversity of transactions of goods and services requiring supplementary order information in addition to basic order information based on characteristics of goods or services.

### Technical Solution

Accordingly, summarizing features of the present invention, an electronic commercial transaction method that facilitates on-line transactions between a seller and a buyer according to an aspect of the present invention for accomplishing the above objects includes the steps of: ordering by submitting basic order information including information of option field items for ordering an object up for sale and supplementary order information based on a provided supplementary order form; and processing to provide the object up for sale from the seller to the buyer by checking a supplement request of the order information for the object up for sale.

The electronic commercial transaction method may further include the step of: before the ordering step, registering, by the seller, a form provided by a server operator or a form registered by the seller for the electronic commercial transactions as the supplementary order form when the seller registers the object up for sale. The electronic commercial transaction method may further include the step of: before the registering step, determining whether to register the form provided by the operator or the form registered by the seller according to a credit rating of the seller. When the seller registers another object up for sale in the same category, a process of determining whether to register the same supplementary order form as a previously registered form for the object up for sale may be omitted.

The registering step may use at least one of a type of uploading a file or text to at least one input window described by text on a page for sale of an object, a type of uploading a file or text using an application downloaded to a terminal, a type of uploading a file or text to a seller database using a web file or an access X file accessible to the seller database, and a type of uploading a file or text using a web file or an access X file loaded at a Uniform Resource Locator (URL).

Each supplementary order form to be registered may be managed in a master table, a corresponding supplementary order form or forms may be provided through a joint table when a purchase request for each object up for sale corresponding to at least one of supplementary order forms of the master table is made, and the supplementary order form or forms submitted in an order may be managed in an object table and provided when the seller or buyer makes a check request.

When the order information supplement request is received from the seller in the processing step, the request of the seller and a supplementary order form re-submitted by the buyer in response to a request of the seller may be managed as a history in a history table until corresponding information is supplemented.

In the processing step, a corresponding request may be reported to the buyer through a Short Message Service (SMS) or e-mail when the order information supplement request is received from the seller, and a corresponding request may be reported to the seller through an SMS or e-mail when the order information supplement request is received from the buyer.

When the order information supplement request is received from the seller in the processing step, violation by the seller may be reported to the operator if a corresponding request is against a predetermined private information protection policy.

After the ordering step, the supplementary order information may be submitted and then confirmed on a seller-dedicated screen for a given duration only.

According to another aspect of the present invention, an electronic commercial transaction method includes the steps of: registering, by a seller, a form provided by an operator or a form registered by a seller as a supplementary order form when the seller registers an object up for sale; providing a buyer terminal with option field items when the object up for sale is ordered, and submitting basic order information from the buyer terminal according to the option field items; and providing the buyer terminal with the registered supplementary order form when the object up for sale is ordered, and submitting supplementary order information from the buyer terminal according to the supplementary order form in addition to the basic order information.

According to still another aspect of the present invention, an electronic commercial transaction system includes: an on-line market server that supports electronic commercial transactions on the Internet. The on-line market server includes a controller that controls on-line transactions between a seller and a buyer, and the controller controls an operation for ordering by submitting basic order information including information of option field items for ordering an object up for sale and supplementary order information based on a provided supplementary order form, and performs a process of providing the object up for sale from the seller to the buyer by checking an order information supplement request for the object up for sale.

According to yet another aspect of the present invention, an on-line market system includes: a supplementary form register that registers a form provided by an operator or a form registered by a seller as a supplementary order form when the seller registers an object up for sale; a broker that provides a buyer terminal with option field items when the object up for sale is ordered and performs a process of submitting basic order information from the buyer terminal according to the option field items; and a supplementary form submitter that provides the buyer terminal with the registered supplementary order form when the object up for sale is ordered and submits supplementary order information from the buyer terminal according to the supplementary order form in addition to the basic order information.

The supplementary form submitter may perform a process of providing the object up for sale from the seller to the buyer by checking a supplement request of the order information for the object up for sale.

The on-line market system may further include: a registration approver that determines whether to register the form provided by the operator or the form registered by the seller according to a credit rating of the seller.

The on-line market system may further include: a private information protector that provides the supplementary order information by determining whether a given time has elapsed after submitting the supplementary order information when a check request for the supplementary order information of the order information for the object up for sale is identified on a seller-dedicated screen, and receives a notification of violation by the seller from the buyer and reports the violation to an operator if a corresponding request is against a predetermined private information protection policy when an order information supplement request is received from the seller.

The on-line market system may further include: a message sender that reports a corresponding request to the buyer through an SMS or e-mail when an order information supplement request for the object up for sale is received from the seller, and reports a corresponding request to the seller through an SMS or e-mail when an order information supplement request for the object up for sale is received from the buyer.

### ADVANTAGEOUS EFFECTS

According to the present invention, an electronic commercial transaction method and system can allow a seller to efficiently prepare and deliver goods or services by receiving all supplementary order information from a buyer using various supplementary order forms registered in an on-line open market without exchanging information in an off-line mode.

According to the present invention, an electronic commercial transaction method and system can extend and promote on-line transactions by supporting diversity of transactions for goods or services requiring supplementary order information in addition to basic order information based on characteristics of goods or services.

### BRIEF DESCRIPTION OF DRAWINGS

FIG. 1 is a diagram illustrating an on-line market system according to an exemplary embodiment of the present invention.

FIG. 2 is a block diagram of an on-line market server according to an exemplary embodiment of the present invention.

FIG. 3 is a block diagram of a supplementary form DB according to an exemplary embodiment of the present invention.

FIG. 4 is a diagram illustrating a supplementary form DB according to an exemplary embodiment of the present invention.

FIG. 5 is a diagram illustrating a brokerage service for clothing on which an image needs to be imprinted according to an exemplary embodiment of the present invention.

FIG. 6 is a diagram illustrating an example of supplementary order information according to an exemplary embodiment of the present invention.

FIG. 7 is a flowchart illustrating an operation of an on-line market system according to an exemplary embodiment of the present invention.

### MODE FOR THE INVENTION

Hereinafter, exemplary embodiments of the present invention will be described in detail with reference to the accompanying drawings. The present invention is not limited to the embodiments. In the drawings, like reference numerals refer to like elements.

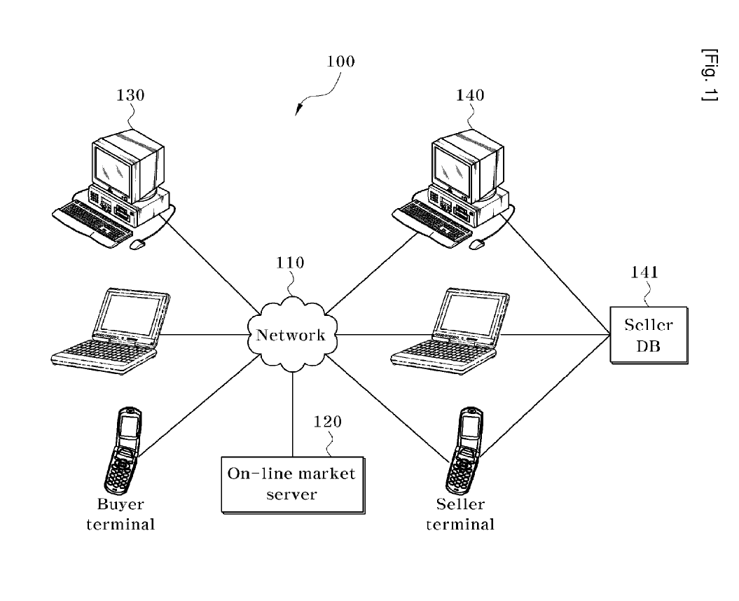

FIG. 1 is a diagram illustrating an on-line market system 100 for electronic commercial transactions according to an exemplary embodiment of the present invention. Referring to FIG. 1, the on-line market system 100 for electronic commercial transactions according to the exemplary embodiment of the present invention can include a network 110, an on-line market server 120, a buyer terminal 130, a seller terminal 140, and a seller database (DB) 141.

Here, the network 110 may be wired or wireless Internet or a core network integrated with a wired public network, a wireless mobile communication network, or the mobile Internet. As a server that facilitates a general sale and purchase, auction, reverse auction, deal, etc. of goods or services between a buyer and a seller by operating an on-line shopping mall through the network 110, the on-line market server 120 receives the registration of various goods or services to be sold by the seller using the seller terminal 140 through the network 110 and provides information about the registered goods or services to the buyer terminal 130 through the network 110, thereby allowing the buyer to buy desired goods or services.

Here, goods or services as objects to be sold include not only general brand goods or services, but also handiworks, returned goods with a reduced price, secondhand goods, goods to be purchased by a group, etc., and services requiring mental or physical labor such as interior work, construction work, legal service, etc. In the present invention, the goods or services further include other goods or services requiring supplementary order information such as a sale of image-imprinted clothing, a mobile phone sale requiring a subscription application form and a copy of a resident registration certificate, an overseas travel goods sale requiring a contract document and a passport/visa, and a manufactured model sale requiring a design drawing and a description.

The on-line market server 120 can process payment for an object selected and purchased by the buyer from a list of objects to be sold, and can perform a process required for delivery such as a process of notifying the seller that money has been paid for the sold object and a process of positioning the object in delivery or retrieving a positioning result such that the object for which money has been paid is delivered to the buyer.

The buyer terminal 130 and the seller terminal 140 are generally computers such as a desktop Personal Computer (PC) or a notebook PC, but are not limited thereto. The buyer terminal 130 and the seller terminal 140 may be any type of wired/wireless communication device capable of using a bidirectional electronic commercial service by accessing the on-line market server 120 over the network 110. For example, the buyer terminal 130 and the seller terminal 140 include mobile terminals such as a cellular phone, a Personal Communications Services (PCS) phone, and a synchronous/asynchronous International Mobile Telecommunication-2000 (IMT-2000) phone for communicating over the wireless or mobile Internet. In addition, the buyer terminal 130 and the seller terminal 140 comprehensively mean all wired/wireless appliance/communication devices having a user interface to access the on-line market server 120, such as a palm PC, Personal Digital Assistant (PDA), Smart phone, Wireless Application Protocol (WAP) phone, and mobile play station.

Specifically, in the present invention, the on-line market server 120 can register a form (basically provided form) provided by a server DB when the seller registers objects (goods or services) to be sold, and a form (seller-registered form) registered by the seller on the basis of the seller DB 141, as a supplementary order form such that the above-described supplementary order information can be efficiently processed without exchanging information for goods or services to be sold. Only sellers having at least a predetermined rating can use the supplementary order form according to the present invention by determining whether to register the basically provided form or the seller-registered form according to a credit rating of a seller when the above-described supplementary order form is registered. When the seller directly registers another object up for sale in the same category, a corresponding supplementary order form can be used by omitting a process of determining whether to register the same supplementary order form as a previously registered form for a corresponding object up for sale. Accordingly, the on-line market server 120 enables an order to be made by providing basic order information including information of option field items (for example, a quantity, color, size, additional goods for a bundle sale by a seller) for ordering an object up for sale and supplementary order information (additionally uploaded text or file information) based on a corresponding supplementary order form, and can process a corresponding object to be provided from the seller to a buyer by checking a supplement request of order information for the object.

As described above, all supplementary order information can be received from buyers using various supplementary order forms for goods or services through the on-line market server 120 that facilitates electronic commercial transactions for objects to be sold, such that sellers can efficiently prepare and deliver corresponding goods or services without information exchange in an off-line mode. Therefore, a variety of merchandise deals can be supported and electronic commercial transactions can be extended and promoted for the sale of goods or services requiring supplementary order information in addition to basic order information based on characteristics of goods or services through the on-line market server 120 according to the present invention.

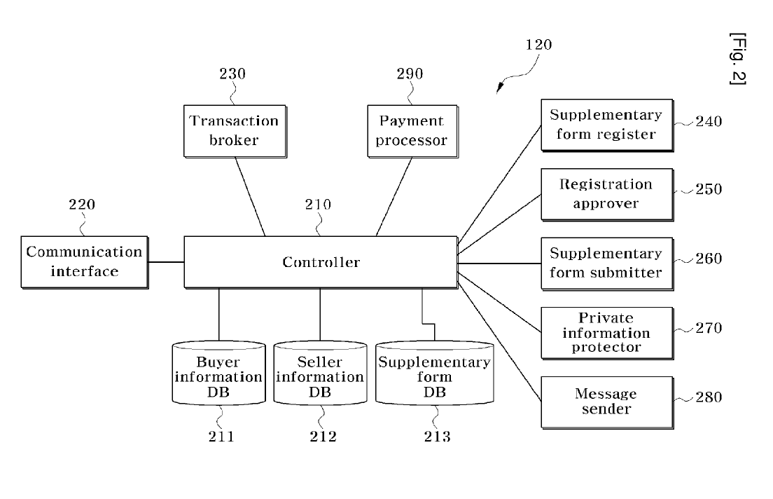

FIG. 2 is a block diagram of the on-line market server 120 according to an exemplary embodiment of the present invention. Referring to FIG. 2, the on-line market server 120 according to the exemplary embodiment of the present invention includes a controller 210, a buyer information DB 211, a seller information DB 212, a supplementary form DB 213, a communication interface 220, a broker 230, a supplementary form register 240, a registration approver 250, a supplementary form submitter 260, a private information protector 270, a message sender 280, and a payment processor 290.

To basically provide an electronic commercial transaction service that facilitates on-line transactions of goods or services between sellers and buyers, the controller 210 controls a goods registration process of a seller, a goods purchase process of a buyer, and a process of delivering goods for which money has been paid. In addition, the controller 210 corresponds to a processor for controlling the overall operation of the above-described elements of the on-line market server 120. According to the present invention, the controller 210 can control an operation for enabling an order to be made by providing basic order information including information of option field items (for example, quantity, color, size, and additional goods for a bundle sale by a seller) for ordering an object up for sale, and supplementary order information (additionally uploaded text or file information) based on a corresponding supplementary order form, and process a corresponding object to be provided from the seller to a buyer by checking a supplement request of order information for the object.

The seller terminal 140 can access the on-line market server 120 over the network 110 and use a brokerage service for sale of goods or services in the on-line market server 120 according to a wired/wireless communication process by the communication interface 220. The seller can join a service of the on-line market server 120 for membership as a customer to use the service through the seller terminal 140. Seller information (for example, a seller ID, a password, a contact address, etc.) and goods information (for example, prices, names, brands, and characteristics of goods, etc.) registered by the membership seller is registered in the seller information DB 212. Upon registration of objects (goods or services) to be sold requiring supplementary order information, the seller can selectively register a form (seller-registered form) based on the seller DB 141 and a form (basically provided form) provided by a server operator as a supplementary order form. As described above, the registered supplementary order form corresponding to an object up for sale can be managed in the supplementary form DB 213. Here, the seller may be an operator of another Internet site and the seller terminal 140 may be a predetermined server operated by the seller. Accordingly, an interworking operation can be performed to automatically transmit/receive necessary information such as goods registration information or contract information between the on-line market server 120 and the seller terminal 140.

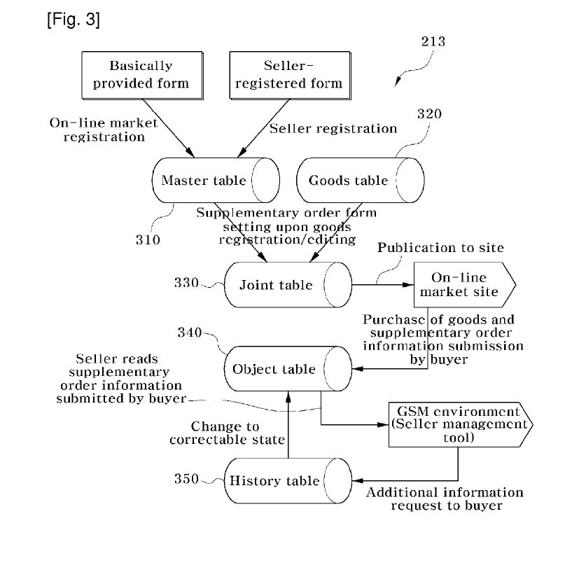

The buyer terminal 130 can also access the on-line market server 120 over the network 110 and use a brokerage service for sale of goods or services in the on-line market server 120 according to a wired/wireless communication process by the communication interface 220. The buyer can join a service of the on-line market server 120 for membership as a customer to use the service through the buyer terminal 130. Buyer information, for example, a buyer ID, a password, a contact address, shopping basket information, goods information in a bid, goods information of a successful bid, goods information in a deal, information of goods for which money has been paid, delivery information, purchase decision information, etc., is stored in the buyer information DB 211. When the buyer buys objects (goods or services) to be sold requiring supplementary order information, the supplementary order information of a file or text submitted by filling in the supplementary order form can be managed in an object table of the supplementary form DB 213 (see reference numeral 350 of FIG. 3) in relation to buyer information, seller information, and contract information.

To facilitate the sale of goods or services registered by the seller as described above, the broker 230 can provide the buyer terminal 130 with information about goods or services to be sold stored in the seller information DB 212 through a web page. The broker 230 can find goods for a search term from the buyer terminal 130 on the basis of names or information of goods and provide the buyer terminal 130 with a list of goods through a web page.

The broker 230 can provide an order page for an immediate purchase, etc. by checking option field items required for an order of the buyer. For example, the option field items may differ according to a type of object up for sale and a field for selecting or recording a quantity, a field for selecting or recording a color, a field for selecting or recording a size, and a field for selecting or recording additional goods for a bundle sale by the seller can be provided to the buyer terminal 130. Accordingly, the buyer buys goods by selecting or recording required items, such that basic order information including corresponding item information (a quantity, a color, a size, and additional goods for a bundle sale by a seller) can be submitted to the server 120.

If needed, the supplementary form submitter 260 can provide the buyer terminal 130 with a supplementary order form registered by the seller when a give tag is clicked on an order page, etc. in the case where an object up for sale requiring the above-described supplementary order information is ordered. Accordingly, the supplementary form submitter 260 can perform a process such that the buyer terminal 130 can submit supplementary order information (additionally uploaded text or file information) according to a corresponding supplementary order form in addition to the above-described basic order information.

When the buyer selects payment for corresponding goods or services after submitting the above-described basic order information (a quantity, a color, a size, and additional goods for a bundle sale by a seller) or the supplementary order information (additionally uploaded text or file information), the broker 230 can provide the buyer terminal 130 with payment screen information of a corresponding object up for sale by the seller for which the buyer has selected the payment through a web page. On the basis of the payment screen information, buyer-related information (a buyer name, an ID, a contact telephone number, etc.), payment object information, a payment amount, a delivery destination, and a payment type (a credit card, bank deposit, real-time account-to-account transfer, or cyber money) can be selected or input by the buyer. After all necessary information of the payment screen is input and checked, the payment processor 290 processes the payment after performing an authentication procedure using a certificate, etc. Unless the buyer requests a return or refund after receiving goods or services according to the payment, the approval of purchase decision is received from the buyer terminal 130, such that a fee can be paid according to a given commission policy and sale money can be transferred to a seller account.

On the other hand, the supplementary form register 240 manages a supplementary order form provided by an operator and a supplementary order form registered by a seller such that the above-described supplementary order form can be used.

Referring to FIG. 3, the supplementary form DB 213 includes a master table 310, a goods table 320, a joint table 330, an object table 340, and a history table 350.

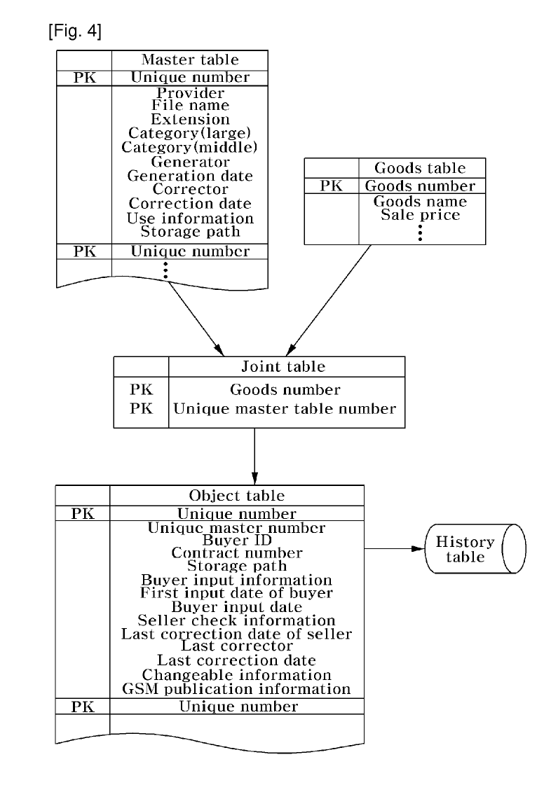

The supplementary form register 240 stores and manages the supplementary order form (basically provided form) provided by the operator and the supplementary order form (seller-registered form) registered by the seller in the master table 310 by assigning a Primary Key (PK) shown in FIG. 4 to the supplementary order form. For example, as the basically provided form provided by the operator, a web file, an active X file, or an application capable of uploading simple text, an application file, or an image file required to buy image-imprinted clothing, a mobile terminal, overseas travel goods, a manufactured model can be managed in the master table 310. When it is difficult to collect all information required to make an order using only the supplementary order form provided by the operator, a web file, an active X file, or an application capable of uploading a subscription application form, a description, a contract document, a copy of a resident registration certificate, a copy of a passport/visa, a design drawing, and a description can be managed as the seller-registered form in the master table 310. For example, a provider of a supplementary form of each unique registration number, a file name, a file extension, a category (large/middle) of an object up for sale, a generator like an operator/seller, a generation date, a corrector, a correction date, use information, a storage path, etc. are managed in the master table 310.

When the seller registers a corresponding object up for sale, the supplementary form register 240 can correspond and register the object by selecting the supplementary order form provided by the operator or the supplementary order form independently registered by the seller. The goods table 320 performs management by assigning a goods number like a PK to goods on the basis of goods information registered for sale by the seller and by causing the PK as shown in FIG. 4 to correspond to the goods information of a name and price of goods. When the seller registers a corresponding object up for sale by selecting the supplementary order form provided by the operator or the supplementary order form independently registered by the seller, the supplementary form register 240 manages the corresponding object up for sale by causing a unique number by reference of a PK managed in the master table 310 to correspond to a goods number by reference of a PK managed in the goods table 320. As shown in FIG. 4, an object up for sale can correspond to at least one of supplementary order forms of the master table 310 and can be managed in the joint table 330.

In addition, for system simplification, the goods table 320 can be independently used by removing the master table 310 and the joint table 330 from the supplementary form DB 213. For example, the goods table 320 can manage a supplementary order form or forms registered by the seller by corresponding to each object (goods) to be sold to which the above-described PK is assigned as well as the supplementary order form (basically provided form) provided by the operator and the supplementary order form (seller-registered form) registered by the seller.

When a corresponding supplementary order form is registered along with an object up for sale, the registration approver 250 can determine whether to register the supplementary order form provided by the operator or the supplementary order form provided by the seller according to a credit rating of the seller. For example, only sellers with at least a predetermined score can register necessary supplementary order forms according to credit scores of sellers evaluated by a buyer or operator based on a delivery state, a quality satisfaction level, a payment amount, etc. associated with goods or services of the sellers. However, when the seller registers the same supplementary order form as a previously registered form for a corresponding object up for sale like the case where the seller directly registers another object up for sale in the same category, a process of determining whether to register the supplementary order form can be omitted.

When a supplementary order form corresponding to goods or services is registered and managed in the master table 310, the buyer orders an object up for sale. The supplementary form submitter 260 can provide the buyer terminal 130 with a corresponding supplementary order form or forms managed in the joint table 330 (or the master table and the goods table in a case where the joint table is absent) when a predetermined tag is clicked on an order page, etc. In addition to the above-described basic order information, a process can be performed such that the buyer terminal 130 can submit supplementary order information (additionally uploaded text or file information) according to a corresponding supplementary order form.

For example, when the predetermined tag for submitting the above-described supplementary order form is clicked on a purchase page of an order page, the buyer terminal 130 can submit the supplementary order information by uploading a file or text to at least one input window described in text provided as a corresponding supplementary form by referring to the joint table 330 (or the master table and the goods table in a case where the joint table is absent) according to operation of the supplementary form submitter 260 of the server 120. For example, a name, a resident registration number, a contact address, etc. can be recorded on a predetermined application form and a necessary image file can be uploaded.

After downloading an application provided as a corresponding supplementary form by referring to the joint table 330 (or the master table and the goods table in a case where the joint table is absent) according to operation of the supplementary form submitter 260, the buyer terminal 130 can submit the supplementary order information by executing a corresponding application and uploading a file or text on a predetermined application form. The buyer terminal 130 can submit the supplementary order information by uploading a file or text to the seller DB 141 through a web file or active X file provided as a corresponding supplementary form and accessible to the seller DB 141 by referring to the joint table 330 (or the master table and the goods table in a case where the joint table is absent) according to operation of the supplementary form submitter 260 of the server 120. The buyer terminal 130 can submit the supplementary order information by uploading a file or text to the seller DB 141 through a web file or active X file provided as a corresponding supplementary form and loaded at a Uniform Resource Locator (URL) by referring to the joint table 330 (or the master table and the goods table in a case where the joint table is absent) according to operation of the supplementary form submitter 260.

When the buyer submits the supplementary order form and pays money, the supplementary form submitter 260 can perform a process such that an object up for sale is provided from the seller to the buyer by checking a supplement request of order information (basic order information, supplementary order information, payment information, etc.) for each object up for sale. When the buyer makes an order on an order page, etc., a supplementary order form or forms to be submitted can be managed in the object table 340 by assigning a unique number as a PK as shown in FIG. 4. When a check request is made through order information, a corresponding supplementary order form can be corrected and provided. For example, the object table 340 manages a unique master number to each unique registration number (a form number in the master table), a buyer ID, a contract number, a storage path, buyer input information, a first input date of the buyer, a buyer input date, seller check information, a last correction date of the seller, a last corrector, a last correction date, changeable information, G-market Seller Management (GSM) publication information, etc. The seller can read order information of his/her goods or services from a predetermined seller-dedicated screen according to GSM and the buyer can read his/her order information from a shopping basket page, an order/payment page, an order completion page, my shopping information page, an order state page, etc.

Specifically, the buyer can correct and re-submit the supplementary order form before a delivery process of goods or services by reading the above-described order information, and the seller can make a correction request for the supplementary order form when an additional request or error is present. A history related to the correction request, for example, request information of the buyer or seller and a corrected and re-submitted supplementary order form, can be managed in the history table 350.

When supplementary order information is deficient in order information on the pre-determined seller-dedicated screen for checking transaction information, the seller can make a supplement request to the buyer. At this time, the message sender 280 reports a corresponding request to the buyer using a Short Message Service (SMS) or e-mail. When the supplement request of order information for a corresponding object up for sale is received from the buyer, corresponding request information can be reported to the seller in the SMS or e-mail. Specifically, the number of supplement requests of sellers may be greater than that of buyers. When the supplement request of corresponding order information is received from the seller, a corresponding supplementary order form managed in the object table 340 can change to a correctable state. Until corresponding information is supplemented, a request of the seller and a supplementary order form re-submitted by the buyer in response to the request of the seller as a history can be managed in the history table 350.

When the seller makes a check request for supplementary order information of order information for a corresponding object up for sale on the seller-dedicated screen based on GSM, the private information protector 270 provides the supplementary order information to the seller in a given period based on a predetermined private information protection policy, for example, in one week after corresponding supplementary order information is submitted. When a supplement request for a supplementary order form of the corresponding supplementary order information is received from the seller, the private information protector 270 can receive a notification of violation by the seller and provide an operator with the received notification if a corresponding request is against a predetermined private information protection policy.

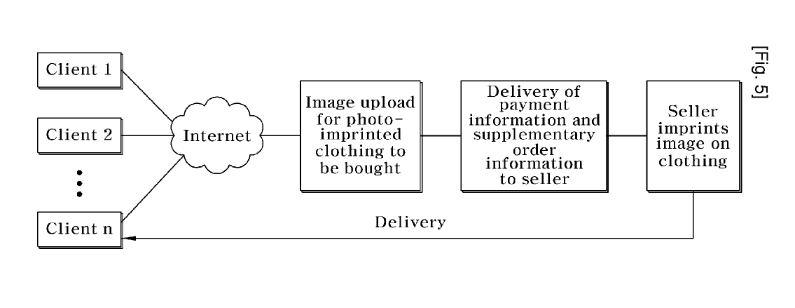

FIG. 5 is a diagram illustrating a brokerage service for clothing on which an image needs to be imprinted according to an exemplary embodiment of the present invention.

Referring to FIG. 5, the on-line market server 120 capable of providing a service in an open market form according to the present invention can receive an order for a corresponding object up for sale by the seller for providing image-imprinted clothing from multiple clients as buyers over a network such as the Internet. For the above-described clothing imprinting service, an exact order description about an image to be printed, a print position, etc. is required. Basic order information of quantity, color, size, etc. can be received from the client. Supplementary order information of a description about an image or an image file can be uploaded through a supplementary order form in relation to the image to be printed. When the basic order information and the supplementary order information are received, the on-line market server 120 provides the seller with order information including corresponding payment information with the basic order information and supplementary order information. Accordingly, the seller reads the order information, imprints an image on corresponding clothing, and delivers the clothing. When the seller makes a request for correcting the supplementary order information without exchanging special information related to the order from the buyer in the off-line mode, the correction request can be made through the seller-dedicated screen based on GSM and the buyer can make a correction through the buyer-dedicated screen and report the correction.

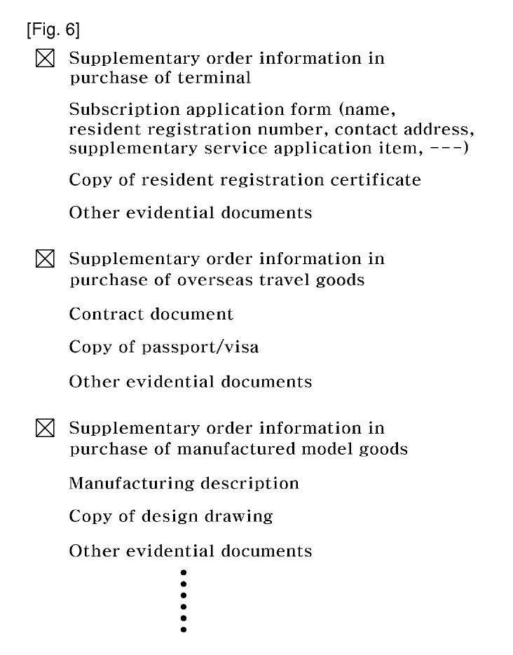

To support a variety of merchandise deals in an on-line open market through the above-described supplementary order form, the on-line market server 120 according to the present invention can comprehensively provide shopping brokerage services for not only a sale of image-imprinted clothing, but also sales of other goods or services requiring supplementary order information such as a mobile phone sale requiring a subscription application form, a copy of a resident registration certificate, and other evidential documents, a sale of overseas travel goods requiring a contract document, a passport/visa, and other evidential documents, and a manufactured model sale requiring a design drawing, a description, and other documents, as shown in FIG. 6, by a similar method.

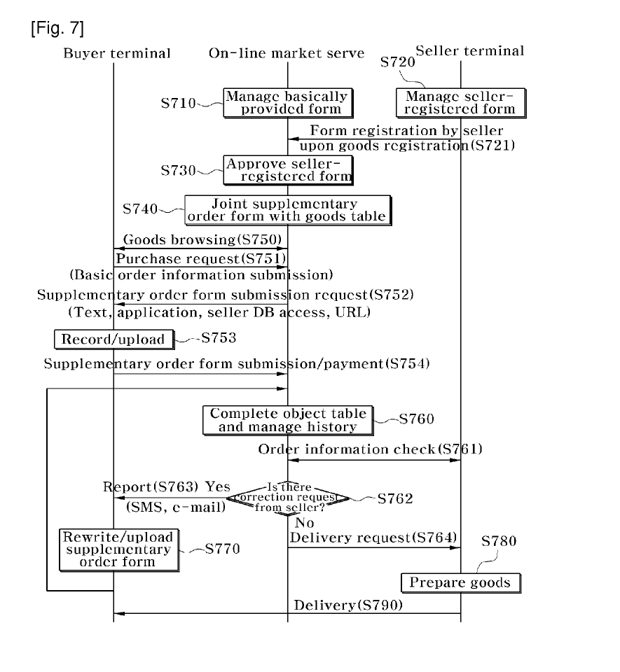

Hereinafter, operation of the on-line market system 100 according to an exemplary embodiment of the present invention will be described in detail with reference to the flowchart of FIG. 7.

First, the on-line market server 120 manages a basically provided form provided by an operator, a web file, an active X file, an application capable of uploading simple text, an application file, or an image file required to buy image-imprinted clothing, a mobile terminal, overseas travel goods, or a manufactured model, in the master table 310 (S710).

The seller can also manage a supplementary order form in the seller DB 141 and corresponding files can be managed in the seller DB 141 such that the buyer terminal 130 can access the seller DB 141 using a web file or an active X file accessible to the seller DB 141 (S720). The seller can register the supplementary order form required for the master table 310 of the on-line market server 120 through the seller terminal 140. For example, when it is difficult to collect all information required to make an order using only the supplementary order form provided by the operator, the seller can additionally register a web file, an active X file, or an application capable of uploading, for example, a subscription application form, a description, a contract document, a copy of a resident registration certificate, a copy of a passport/visa, a design drawing, and a description in the master table 310 in relation to corresponding goods or services.

In addition, the goods table 320 can be independently used by removing the master table 310 and the joint table 330 from the supplementary form DB 213. For example, the goods table 320 can manage the supplementary order form (basically provided form) provided by the operator and the supplementary order form (seller-registered form) registered by the seller.

When the seller registers a corresponding object up for sale, the supplementary form register 240 can correspond and register the object by selecting the supplementary order form provided by the operator or the supplementary order form independently registered by the seller (S721).

When the above-described supplementary order form is registered, the registration approver 250 can determine whether to register the basically provided form or the seller-registered form according to a credit rating of a seller (S730). For example, only sellers with at least a predetermined score can register necessary supplementary order forms according to credit scores of sellers evaluated by a buyer or operator based on a delivery state, a quality satisfaction level, a payment amount, etc. associated with goods or services of the sellers. However, when the seller registers the same supplementary order form as a previously registered form for a corresponding object up for sale like the case where the seller directly registers another object up for sale in the same category, a process of determining whether to register the supplementary order form can be omitted.

Each supplementary order form registered as described above is assigned a PK as shown in FIG. 4 and is managed in the master table 310. An object of the goods table 320 to be sold corresponds to at least one of supplementary order forms of the master table 310 and is managed in the joint table 330 (S740). When the goods table 320 is used by removing the master table 310 and the joint table 330 from the supplementary form DB 213, a supplementary order form or forms by the seller are managed in the goods table 320 in which each object up for sale is assigned a PK.

While the supplementary order form corresponding to goods or services is registered and managed in the joint table 330, the buyer can browse through goods or services to be provided through the on-line market server 120 through the buyer terminal 130 (S750). The broker 230 of the on-line market server 120 provides the buyer terminal 130 with information about goods or services up for sale stored in the seller information DB 212 for browsing by the buyer through a web page. The broker 230 can find goods for a search term from the buyer terminal 130 on the basis of names or information of goods and provide the buyer terminal 130 with a list of goods through a web page. The broker 230 can provide an order page for an immediate purchase, etc. by checking option field items required for an order of the buyer. For example, the option field items may differ according to a type of object up for sale and a field for selecting or recording a quantity, a field for selecting or recording a color, a field for selecting or recording a size, and a field for selecting or recording additional goods for a bundle sale by the seller can be provided. Accordingly, the buyer buys goods by selecting or recording required items, such that basic order information including corresponding item information (a quantity, a color, a size, and additional goods for a bundle sale by a seller) can be submitted to the server 120 (S751).

If an object up for sale requiring the above-described supplementary order information is ordered, the supplementary form submitter 260 of the on-line market server 120 can provide the buyer terminal 130 with a supplementary order form registered by the seller when the above-described basic order information is submitted or a given tag is clicked on an order page. Accordingly, a process can be performed such that the buyer terminal 130 can submit supplementary order information (additionally uploaded text or file information) according to a corresponding supplementary order form in addition to the above-described basic order information (S752).

For example, when the predetermined tag for submitting the above-described supplementary order form is clicked on a purchase page of an order page, the buyer terminal 130 can submit the supplementary order information by uploading a file or text to at least one input window described in text provided as a corresponding supplementary form by referring to the joint table 330 according to operation of the supplementary form submitter 260 of the server 120 (S753). For example, a name, a resident registration number, a contact address, etc. can be recorded on an application form displayed on the screen and a necessary image file can be uploaded. After downloading an application according to operation of the supplementary form submitter 260, the buyer terminal 130 can submit the supplementary order information by executing a corresponding application and uploading a file or text on a pre-determined application form. The buyer terminal 130 can submit the supplementary order information by uploading a file or text to the seller DB 141 through a web file or active X file accessible to the seller DB 141 according to operation of the supplementary form submitter 260. The buyer terminal 130 can submit the supplementary order information by uploading a file or text through a web file or active X file loaded at a URL according to operation of the supplementary form submitter 260.

When the buyer selects payment for corresponding goods or services after submitting the above-described order information (a quantity, a color, a size, and additional goods for a bundle sale by a seller) or the supplementary order information (additionally uploaded text or file information) (S754), the broker 230 can provide the buyer terminal 130 with payment screen information of a corresponding object up for sale by the seller for which the buyer has selected the payment through a web page. On the basis of the payment screen information, buyer-related information (a buyer name, an ID, a contact telephone number, etc.), payment object information, a payment amount, a delivery destination, and a payment type (a credit card, bank deposit, real-time account-to-account transfer, or cyber money) can be selected or input by the buyer. After all necessary information of the payment screen is input and checked, the payment processor 290 processes the payment after performing an authentication procedure using a certificate, etc.

A supplementary order form or forms to be submitted are managed in the object table 340 by assigning a unique number as a PK as shown in FIG. 4 when the buyer submits a supplementary order form, pays money, makes an order on an order page, etc., and a corresponding supplementary order form are corrected and provided when the seller or buyer makes a check request using order information (S760). The supplementary form submitter 260 can perform a process such that an object up for sale is provided from the seller to the buyer by checking a supplement request of order information (basic order information, supplementary order information, payment information, etc.) for each object up for sale. The seller can read order information of his/her goods or services from a predetermined seller-dedicated screen according to GSM, and the buyer can read his/her order information from a shopping basket page, an order/payment page, an order completion page, my shopping information page, or an order state page (S761). Specifically, the buyer can correct and re-submit the submitted supplementary order form in a given period, for example, before a delivery process of goods or services, by reading the above-described order information, and the seller can also make a correction request of the supplementary order form when an additional request or error is present. A history related to the above-described correction request, for example, a request of the buyer or seller and a corrected and re-submitted supplementary order form, can be managed in the history table 350.

When supplementary order information is deficient in order information on the pre-determined seller-dedicated screen for checking transaction information, the seller can make a supplement request to the buyer (S762). At this time, the message sender 280 can report corresponding request information to the buyer using an SMS or e-mail (S763). When the supplement request of order information for a corresponding object up for sale is received from the buyer, corresponding request information can be reported to the seller in the SMS or e-mail. Specifically, the number of order information supplement requests of sellers may be greater than that of buyers. Until corresponding information is supplemented when the supplement request of corresponding order information is received from the seller, a request of the seller and a supplementary order form re-submitted by the buyer in response to the request of the seller as a history can be managed in the history table 350 (S770, S760).

When the seller makes a check request for supplementary order information of order information for a corresponding object up for sale on the seller-dedicated screen based on GSM, the private information protector 270 can provide the supplementary order information to the seller in only a given period based on a predetermined private information protection policy, for example, in one week after corresponding supplementary order information is submitted. When a supplement request for a supplementary order form of the corresponding supplementary order information is received from the seller, the private information protector 270 can receive a notification of violation by the seller and provide an operator with the received notification if a corresponding request is against a predetermined private information protection policy.

When all order requirements are satisfied after correction information of the supplementary order information is submitted and the seller repeats the check process, the broker 230 can report a delivery request to the seller terminal 140 through a corresponding dedicated screen such that the delivery can be performed according to order information (S764). As shown in FIGS. 5 and 6, the seller prepares corresponding goods or services (S780) and delivers the goods or services (S790). Unless the buyer request a return or refund after receiving goods or services according to the payment, the payment processor 290 receives the approval of purchase decision from the buyer terminal 130, such that a fee can be paid according to a given commission policy and sale money can be transferred to a seller account.

A method and system disclosed in this specification can be embodied as computer-readable codes on a computer-readable recording medium. The computer-readable recording medium can be any data storage device that can store data readable by a computer system. Examples of the computer-readable recording medium include ROM, RAM, CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion.

Although a few embodiments of the present invention have been shown and described, it will be appreciated by those skilled in the art that various changes may be made to these embodiments without departing from the principles and spirit of the invention, the scope of which is defined by the claims and their equivalents.

1. An electronic commercial transaction method that facilitates on-line transactions between a seller and a buyer, comprising the steps of: ordering by submitting basic order information comprising information of option field items for ordering an object up for sale and supplementary order information based on a provided supplementary order form; and processing to provide the object up for sale from the seller to the buyer by checking a supplement request of the order information for the object up for sale.

2. The electronic commercial transaction method of claim 1, further comprising the step of: before the ordering step, registering, by the seller, a form provided by a server operator or a form registered by the seller for the electronic commercial transactions as the supplementary order form when the seller registers the object up for sale.

3. The electronic commercial transaction method of claim 2, further comprising the step of: before the registering step, determining whether to register the form provided by the operator or the form registered by the seller according to a credit rating of the seller.

4. The electronic commercial transaction method of claim 3, wherein when the seller registers another object up for sale in the same category, a process of determining whether to register the same supplementary order form as a previously registered form for the object up for sale is omitted.

5. The electronic commercial transaction method of claim 2, wherein the registering step uses at least one of a type of uploading a file or text to at least one input window described by text on a page for sale of an object, a type of uploading a file or text using an application downloaded to a terminal, a type of uploading a file or text to a seller database using a web file or an access X file accessible to the seller database, and a type of uploading a file or text using a web file or an access X file loaded at a Uniform Resource Locator (URL).

6. The electronic commercial transaction method of claim 2, wherein each supplementary order form to be registered is managed in a master table, a corresponding supplementary order form or forms are provided through a joint table when a purchase request for each object up for sale corresponding to at least one of supplementary order forms of the master table is made, and the supplementary order form or forms submitted in an order are managed in an object table and provided when the seller or buyer makes a check request.

7. The electronic commercial transaction method of claim 2, wherein a supplementary order form or forms to be registered corresponding to each object up for sale are managed in a goods table, a supplementary order form or forms are provided through the goods table when a purchase request for each object up for sale is made, and a supplementary order form or forms submitted in an order are managed in an object table and provided when the seller or buyer makes a check request.

8. The electronic commercial transaction method of claim 1, wherein when the order information supplement request is received from the seller in the processing step, the request of the seller and a supplementary order form re-submitted by the buyer in response to a request of the seller are managed as a history in a history table until corresponding information is supplemented.

9. The electronic commercial transaction method of claim 1, wherein in the processing step, a corresponding request is reported to the buyer through a Short Message Service (SMS) or e-mail when the order information supplement request is received from the seller, and a corresponding request is reported to the seller through an SMS or e-mail when the order information supplement request is received from the buyer.

10. The electronic commercial transaction method of claim 1, wherein when the order information supplement request is received from the seller in the processing step, violation by the seller is reported to the operator if a corresponding request is against a predetermined private information protection policy.

11. The electronic commercial transaction method of claim 1, wherein after the ordering step, the supplementary order information is submitted and then confirmed on a seller-dedicated screen for a given duration only.

12. An electronic commercial transaction method, comprising the steps of: registering, by a seller, a form provided by an operator or a form registered by a seller as a supplementary order form when the seller registers an object up for sale; providing a buyer terminal with option field items when the object up for sale is ordered, and submitting basic order information from the buyer terminal according to the option field items; and providing the buyer terminal with the registered supplementary order form when the object up for sale is ordered, and submitting supplementary order information from the buyer terminal according to the supplementary order form in addition to the basic order information.

13. A medium for recording a computer-readable program to perform the method of claim 1.

14. An electronic commercial transaction system comprising: an on-line market server that supports electronic commercial transactions on the Internet, wherein the on-line market server comprises a controller that controls on-line transactions between a seller and a buyer, and the controller controls an operation for ordering by submitting basic order information comprising information of option field items for ordering an object up for sale and supplementary order information based on a provided supplementary order form and performs a process of providing the object up for sale from the seller to the buyer by checking an order information supplement request for the object up for sale.

15. An on-line market system comprising: a supplementary form register that registers a form provided by an operator or a form registered by a seller as a supplementary order form when the seller registers an object up for sale; a broker that provides a buyer terminal with option field items when the object up for sale is ordered and performs a process of submitting basic order information from the buyer terminal according to the option field items; and a supplementary form submitter that provides the buyer terminal with the registered supplementary order form when the object up for sale is ordered and submits supplementary order information from the buyer terminal according to the supplementary order form in addition to the basic order information.

16. The on-line market system of claim 15, wherein the supplementary form submitter performs a process of providing the object up for sale from the seller to the buyer by checking a supplement request of the order information for the object up for sale.

17. The on-line market system of claim 15, further comprising: a registration approver that determines whether to register the form provided by the operator or the form registered by the seller according to a credit rating of the seller.

18. The on-line market system of claim 15, further comprising: a private information protector that provides the supplementary order information by determining whether a given time has elapsed after submitting the supplementary order information when a check request for the supplementary order information of the order information for the object up for sale is identified on a seller-dedicated screen, and receives a notification of violation by the seller from the buyer and reports the violation to an operator if a corresponding request is against a predetermined private information protection policy when an order information supplement request is received from the seller.

19. The on-line market system of claim 15, further comprising: a message sender that reports a corresponding request to the buyer through an SMS or e-mail when an order information supplement request for the object up for sale is received from the seller, and reports a corresponding request to the seller through an SMS or e-mail when an order information supplement request for the object up for sale is received from the buyer.

20. A medium for recording a computer-readable program to perform the method of claim 12.
